(19) United States
(12) Patent Application Publication
(10) Pub. No.: US 2010/0297204 A1
(43) Pub. Date: Nov. 25, 2010

(54) PARTICULATE POLYMERS COMPRISING BIOCIDAL ACTIVE SUBSTANCE

(75) Inventors: Hermann Uhr, Leverkusen (DE); Frank Sauer, Langenfeld (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/665,412

(22) PCT Filed: Jun. 11, 2008
(86) PCT No.: PCT/EP08/57298

§ 371 Date: Jul. 29, 2010

(30) Foreign Application Priority Data
Jun. 22, 2007 (DE) 10 2007 028 923.7

(51) Int. Cl. A01N 25/08; A01N 43/78; A01N 43/70; A01P 3/00; A01P 13/00; A01P 7/04; A01P 1/00

(52) U.S. Cl. 424/405; 514/365; 514/245

(57) ABSTRACT

The present invention relates to a particulate polymer matrix containing a biocidal active substance, distributed homogeneously in the polymeric matrix, processes for their preparation, dispersions containing this particulate polymer matrix, and their use as a microbiocidal composition for protecting industrial materials.

The present invention relates to a particulate polymer matrix containing a biocidal active substance, distributed homogeneously in the polymeric matrix, processes for their preparation, dispersions containing this particulate polymer matrix, and their use as a microbiocidal composition for protecting industrial materials.

Biocides, in particular fungicides and algaecides, are used in paint systems and renders for preventing the attack of the systems by fungi and/or algae and the associated visual change and destruction of the paint material itself or of the substrate.

For this purpose, the active substances are incorporated directly or as formulations, such as solutions and dispersions of the active substances, into the suitable systems.

In many cases, however, the long-term effect in the active media, such as paints, is not sufficiently good because the fungicidal and/or algaecidal active substances are dissolved out of the paint film or the render by rainwater or condensation water (so-called “leaching effect”), which leads to a decrease in concentration of these active substances in the coating and hence to a reduction of their biocidal activity. On the other hand, the active substances can be rapidly degraded (hydrolyzed) in the dried renders and paints, which in some cases are strongly alkaline. In some cases, the unprotected active substances are decomposed even in the paint containers and starting materials for the renders and thus lose their intended activity.

Methods for avoiding this by encapsulation of the active substances or by adsorption onto solid carriers have already become known.

Thus, for example, specific formaldehyde-melanin resins are used as wall materials of microcapsules for protecting active substances from hydrolysis in coating materials which have a pH>11 (cf. WO 2004/000953).

EP-A-0758633 describes porous granules which contain chemical substances, such as, for example, also biocides, which slowly release these during use.

Furthermore, microcapsules have become known which preferably contain zinc-pyrithione or irgarol and are prepared by a procedure in which aqueous dispersions of a polymer, one or more active substances and a low-boiling solvent are freed from the solvent with vigorous stirring and the resulting microcapsules are isolated by filtration (cf. US-A-2006/0246144). Encapsulation of active substances for specific crop protection applications are already known from WO-A-97/34474.

Common to all processes described is that either the solid or dissolved active substances is enclosed (encapsulated) with an encapsulation material, the active substance is bound by adsorption onto a carrier or solutions of the active substance with polymers are evaporated down so that the active substance is then present as a core enclosed by a polymer wall in the form of fine spheres.

A disadvantage is that the microcapsules used are either destroyed too easily or in turn prepared with the use of solvents whose excessively high contents in the microcapsules limit their use.

It was therefore an object to eliminate the disadvantages of the prior art.

Surprisingly, a particulate polymer matrix has now been found, containing a biocidal active substance homogeneously distributed in the polymeric matrix, characterized in that
the polymer is a thermoplastic polymer,
more than 90%, in particular more than 95%, of all particles having a particle size of less than 100 μm, preferably from 1 to 50 μm, and
the polymer matrix having an active substance content of from 2 to 80% by weight.

The polymer matrix preferably comprises monolithic particles in which the active substance is homogeneously distributed in the matrix. “Homogeneously distributed” is also understood as meaning the distribution of an active substance introduced into the matrix after mixing and extrusion. Merely for clarification, it may be stated that microcapsules which have an active substance core which is surrounded by a thin polymer wall is not covered by the tei in polymer matrix.

The thermoplastic polymers which can be used according to the invention are a multiplicity of different polymers. Polyacrylates, polyalkylene glycols, in particular polyethylene glycols or polyethylene-polypropylene glycol copolymers (block copolymers or randomly distributed), polyurethanes, polyamides, polyureas, polycarbonates, polyesters or mixtures thereof are preferably used.

However, it is also possible in principle to use other polymers not mentioned here or mixtures thereof as carrier materials. The glass transition temperature T_{g} of the thermoplastic polymers is in general from 30 to 250° C., preferably from 50 to 200° C.

The thermoplastic polyacrylates are in principle all familiar polyacrylates which are solid at 40° C., preferably those of the general formula (I)

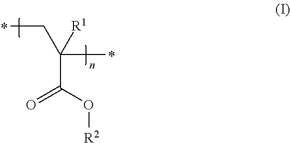

in which
R may be hydrogen, linear, branched or cyclic, aliphatic or aromatic radicals optionally provided with functional substituents, such as hydroxyl, amino, sulfone or epoxy groups, or mixtures thereof.

Preferably, the radicals are methyl, ethyl, isopropyl, tert-butyl, cyclohexyl, 2-ethylhexyl, dodecyl, stearyl, 2-hydroxyethyl or 2-dimethylaminoethyl or mixtures thereof.

The polyacrylates used are preferably obtained by free radical polymerization. Preferred polyacrylates are copolymers of acrylic acid and methacrylates, which are optionally polymerized with further comonomers, such as, for example, alkyl acrylates, methacrylic acid and amides thereof, acrylonitrile, vinyl chloride, vinylidene chloride, vinyl acetate, butadiene or styrene, for achieving the desired properties.

The molecular weights of the polyacrylates may vary within a very wide range; they preferably have a molar mass of 10 000-100 000 g/mol.

In particular, polyethylene glycols and polyethylene-polypropylene glycol copolymers (block copolymers or randomly distributed)—designated as polyethers below—may be mentioned as polyalkylene glycols. Those of the general formula (II) which are solid at 40° C. are preferred.

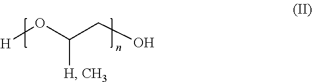

In general, the molecular weight of the polyalkylene glycols may vary within a range from 5000 g/mol to 5 000 000 g/mol. Common to all polyalkylene glycols of the preferred type described above is that they form as a result of ring-opening polymerization of ethylene oxide and/or propylene oxide. It is also possible to use polyethers which are branched by the introduction of polyhydric alcohols.

The polyurethanes may be all customary, preferably solid polyurethanes. Preferably, the polyurethanes have repeating units of the general formula (III)

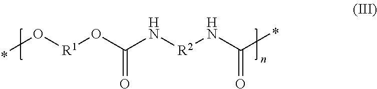

in which
R1 and R2 are aliphatic and/or aromatic groups.

The polyurethanes are preferably prepared from dihydric or higher-hydric alcohols and (poly)isocyanates. Preferably, the polyurethanes are prepared from polyester diols and/or polyether diols and diisocyanates, such as, for example, 2,4- or 2,6-toluoylene diisocyanate (TDI), 4,4′-methylene di(phenylisocyanate) (MDI), 4,4′-methylenedicyclohexyl isocyanate (HMDI) or 1,6-hexamethylene diisocyanate (HDI).

It is possible to use as polyamides all polyamides which are preferably solid at 40° C. and in principle are held together by amide bonds (—NH—CO—). The so-called homopolyamides may be both the amino carboxylic acid types (AS) and diamine-dicarboxylic acid types (AA-SS; here, A designates amino groups and S carboxyl groups). However, it is also possible to use copolyamides. Polyaramides which are composed exclusively of aromatic radicals (e.g. p-phenylenediamine and terephthalic acid) can likewise be used. In addition, block copolymers of polyamides and polyethers can also be used.

All thermoplastic polymers with repeating units of the general formula (IV)

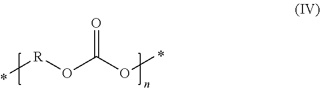

can be used as polycarbonates. These are formally polyesters of carbonic acid with aliphatic and/or aromatic dihydroxy compounds.

They preferably form by polycondensation of the dihydroxy compounds with phosgene or carbonic acid diesters. It is also possible to use mixtures of different dihydroxy compounds. If, for example, different bisphenols are used in multistage polycondensations, block polymers are obtained. If dicarboxylic acid dichlorides are used in addition to the carbonic acid esters, polyester polycarbonates which can likewise be used in the processes according to the invention are obtained.

Polyesters which may be used are preferably all polyesters which are solid at 40° C. and in principle are held together by ester bonds (—O—CO—). The so-called homopolyesters may be both the hydroxycarboxylic acid types (AB) and dihydroxydicarboxylic acid types (AA-BB). By choosing trihydric or polyhydric alcohols or tribasic or polybasic carboxylic acids, it is also possible to obtain branched or crosslinked polyesters. The AB types are preferably polyglycolic acids, polylactic acids, poly(β-hydroxybutyric acids), poly(ε-caprolactones) or polyhydroxybenzoic acids. Pure aliphatic AA-BB types are aliphatic diols with aliphatic dicarboxylic acid esters which also contain, as terminal groups, hydroxyl groups which can then also be used, for example, for the preparation of polyester urethanes, such as, for example, polytetramethylene adipates. Preferably used AA-BB types obtained from aliphatic diols and aromatic dicarboxylic acids are polyalkylene terephthalates, such as polyethylene terephthalate, polybutylene terephthalate or poly(1,4-cyclohexanedimethylene terephthalates). It is also possible in each case to use mixtures of the dihydroxy compounds and dihydroxycarboxylic acids.

Purely aromatic polyesters preferably consist of poly(4-hydroxybenzoic acid)s or polycondensates of bisphenol A and phthalic acids.

In addition, it is also possible to use polyesters obtained from unsaturated dicarboxylic acids, which are designated as UP resins.

The preferred polyureas are formally polymers which have repeating units of the general formula (V)

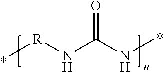

for example contain polyether groups. The polyureas which can be used are not limited here only to “pure” polyureas but it is also possible to use copolymers having other structural units in the main chain, for example urethane-(polyurethanepolyureas), amide-(polyamidopolyureas), imide-(polyimidopolyureas) or carbonate groups (polycarbonate polyureas).

In each case mixtures of two or more of the abovementioned polymers can also be used for establishing the desired properties.

Further auxiliaries which advantageously influence the properties and the stability of the polymers can also be added to the abovementioned polymers. For example, plasticizers and stabilizers, such as antioxidants, free radical scavengers or UV stabilizers, may be mentioned here.

The preferred polymers originate from the groups consisting of the polyacrylates, polyalkylene glycols, polyurethanes and polyamides.

The biocidal active substances are preferably fungicides, algicides, bactericides and/or insecticides.

The algicides are preferably:

acetochlor, acifluorfen, aclonifen, acrolein, alachlor, alloxydim, ametryn, amidosulfuron, amitrole, ammonium sulfamate, anilofos, asulam, atrazine, azafenidin, aziptrotryn, azimsulfuron,
benazolin, benfluralin, benfuresate, belsulfuron, bensulfide, bentazon, benzofencap, benzthiazuron, bifenox, bispyribac, bispyribac-sodium, borax, bromacil, bromobutide, bromofenoxim, bromoxynil, butachlor, butamifos, butralin, butylate, bialaphos, benzoylprop, bromobutide, butroxydim,
carbetamide, carfentrazone-ethyl, carfenstrol, chlomethoxyfen, chloramben, chlorbromuron, chlorflurenol, chloridazon, chlorimuron, chlornitrofen, chloroacetic acid, chloransulam-methyl, cinidon-ethyl, chlorotoluron, chloroxuron, chlorpropham, chlorsulfuron, chlorthal, chlorthiamid, cinmethylin, cinofulsuron, clefoxydim, clethodim, clomazone, chlomeprop, clopyralid, cyanamide, cyanazine, cycloate, cycloxydim, chloroxynil, clodinafop-propargyl, cumyluron, clometoxyfen, cyhalofop, cyhalofop-butyl, clopyrasuluron, cyclosulfamuron,
diclosulam, dichlorprop, dichlorprop-P, diclofop, diethatyl, difenoxuron, difenzoquat, diflufenican, diflufenzopyr, dimefuron, dimepiperate, dimethachlor, dimethipin, dinitramine, dinoseb, dinoseb acetate, dinoterb, diphenamid, dipropetryn, diquat, dithiopyr, diduron, DNOC, DSMA, 2,4-D, daimuron, dalapon, dazomet, 2,4-DB, desmedipham, desmetryn, dicamba, dichlobenil, dimethamid, dithiopyr, dimethametryn,
eglinazine, endothal, EPTC, esprocarb, ethalfluralin, ethidimuron, ethofumesate, ethobenzanide, ethoxyfen, ethametsulfuron, ethoxysulfuron,
fenoxaprop, fenoxaprop-P, fenuron, flamprop, flamprop-M, flazasulfuron, fluazifop, fluazifop-P, fuenachlor, fluchloralin, flufenacet, flumeturon, fluoroglycofen, fluoronitrofen, flupropanate, flurenol, fluridone, fluorochloridone, fluoroxypyr, fomesafen, fosamine, fosametine, flamprop-isopropyl, flamprop-isopropyl-L, flufenpyr, flumiclorac-pentyl, flumipropyn, flumioxzim, flurtamon, flumioxzim, flupyrsulfuron-methyl, fluthiacet-methyl,
glyphosate, glufosinate-ammonium,
haloxyfop, hexazinone,
imazamethabenz, isoproturon, isoxaben, isoxapyrifop, imazapyr, imazaquin, imazethapyr, ioxynil, isopropalin, imazosulfuron, imazomox, isoxaflutole, imazapic, ketospiradox,
lactofen, lenacil, linuron,
MCPA, MCPA-hydrazide, MCPA-thioethyl, MCPB, mecoprop, mecoprop-P, mefenacet, mefluidide, mesosulfuron, metam, metamifop, metamitron, metazachlor, methabenzthiazuron, methazole, methoroptryne, methyldymron, methyl isothiocyanate, metobromuron, metoxuron, metribuzin, metsulfuron, molinate, monalide, monolinuron, MSMA, metolachlor, metosulam, metobenzuron,
naproanilide, napropamide, naptalam, neburon, nicosulfuron, norflurazon, sodium chlorate,
oxadiazon, oxyfluorfen, oxysulfuron, orbencarb, oryzalin, oxadiargyl,
propyzamide, prosulfocarb, pyrazolate, pyrazolsulfuron, pyrazoxyfen, pyribenzoxim, pyributicarb, pyridate, paraquat, pebulate, pendimethalin, pentachlorophenol, pentoxazone, pentanochlor, petroleum oils, phenmedipham, picloram, piperophos, pretilachlor, primisulfuron, prodiamine, profoxydim, prometryn, propachlor, propanil, propaquizafob, propazine, propham, propisochlor, pyriminobac-methyl, pelargonic acid, pyrithiobac, pyraflufen-ethyl,
quinmerac, quinocloamine, quizalofop, quizalofop-P, quinchlorac,
rimsulfuron,
sethoxydim, sifuron, simazine, simetryn, sulfosulfuron, sulfometuron, sulfentrazone, sulcotrione, sulfosate,
tar oils, TCA, TCA-sodium, tebutam, tebuthiuron, terbacil, terbumeton, terbutylazine, terbutryn, thiazafluoron, thifensulfuron, thiobencarb, thiocarbazil, tralkoxydim, triallate, triasulfuron, tribenuron, triclopyr, tridiphane, trietazine, trifluralin, tycor, thdiazimin, thiazopyr, triflusulfuron,
vernolate.

The algicides are very particularly preferably triazine compounds, such as, for example, terbutryn, cybutryn, propazine or terbuton, urea compounds, such as, for example, diuron, benzthiazuron, methabenzthiazuron, tebuthiuron and isoproturon, or uracils, such as, for example, terbacil.

The fungicides are preferably

triazoles, such as:
azaconazole, azocyclotin, bitertanol, bromuconazole, cyproconazole, diclobutrazol, difenoconazole, diniconazole, epoxyconazole, etaconazole, fenbuconazole, fenchlorazol, fenethanil, fluquinconazole, flusilazol, flutriafol, furconazole, hexaconazole, imibenconazole, ipconazole, isozofos, myclobutanil, metconazole, paclobutrazol, penconazole, propioconazole, prothioconazole, simeoconazole, (±)-cis-1-(4-chlorophenyl)-2-(1H-1,2,4-triazol-1-yl)cycloheptanol, 2-(1-tert-butyl)-1-(2-chlorophenyl)-3-(1,2,4-triazol-1-yl)-propan-2-ol, tebuconazole, tetraconazole, triadimefon, triadimenol, triapenthenol, triflumizol, triticonazole, uniconazole and the metal salts and acid adducts thereof;
imidazoles, such as:
clotrimazol, bifonazol, climbazol, econazol, fenapamil, imazalil, isoconazole, ketoconazole, lombazol, miconazole, pefurazoate, prochloraz, triflumizol, thiazolcar 1-imidazolyl-1-(4′-chlorophenoxy)-3,3-dimethylbutan-2-one and the metal salts and acid adducts thereof;
pyridines and pyrimidines, such as:
ancymidol, buthiobat, fenarimol, mepanipyrin, nuarimol, pyroxyfur, triamirol;
succinate dehydrogenase inhibitors, such as:
benodanil, carboxim, carboxim sulfoxide, cyclafluramide, fenfuram, flutanil, furcarbanil, furmecyclox, mebenil, mepronil, methfuroxam, metsulfovax, nicobifen, pyrocarbolid, oxycarboxin, shirlan, seedvax;
naphthalene derivatives, such as:
terbinafin, naftifin, butenafin, 3-chloro-7-(2-aza-2,7,7-trimethyloct-3-en-5-yne);
sulfenamides, such as:
dichlorfluanid, tolylfluanid, folpet, fluorfolpet; captan, captofol;
benzimidazoles, such as:
carbendazim, benomyl, fuberidazole, thiabendazol or the salts thereof;
morpholine derivatives, such as:
aldimorph, dimethomorph, dodemorph, falimorph, fenpropidin, fenpropimorph, tridemorph, trimorphamid and their salts with arylsulfonic acids, such as, for example, p-toluenesulfonic acid and p-dodecylphenylsulfonic acid;
benzothiazoles, such as:
2-mercaptobenzothiazole;
benzothiophene dioxides, such as:
benzo[b]thiophene S,S-dioxide carboxylic acid cyclohexylamide;
benzamides, such as:
2,6-dichloro-N-(4-trifluoromethylbenzyl)benzamide, tecloftalam;
boron compounds, such as:
boric acid, boric acid esters, borax;
isothiazolinones, such as:
4,5-dichloro-N-octylisothiazolin-3-one, 5-chloro-N-octylisothiazolinone, N-octyl-isothiazolin-3-one, benzisothiazolin-3-one; N-butylbenzisothiazol-3-one;
thiocyanates, such as:
thiocyanatomethylthiobenzothiazole, methylene bisthiocyanate;
iodine derivatives, such as:
diiodomethyl-p-tolyl sulfone, 3-iodo-2-propynyl alcohol, 4-chlorophenyl-3-iodopropargyl formal, 3-bromo-2,3-diiodo-2-propenylethyl carbamate, 2,3,3-triiodoallyl alcohol, 3-bromo-2,3-diiodo-2-propenyl alcohol, 3-iodo-2-propynyl-n-butyl carbamate, 3-iodo-2-propynyl-n-hexyl carbamate, 3-iodo-2-propynylcyclohexyl carbamate, 3-iodo-2-propynylphenyl carbamate;
pyridines, such as:
1-hydroxy-2-pyridinethione (and its Cu, Na, Fe, Mn and Zn salts), tetrachloro-4-methylsulfonylpyridine, pyrimethanol, mepanipyrim, dipyrithione, 1-hydroxy-4-methyl-6-(2,4,4-trimethylpentyl)-2(1H)-pyridine;
methoxyacrylates or the like, such as:
azoxystrobin, dimoxystrobin, fluoxastrobin, kresoxim-methyl, metominostrobin, orysastrobin, picoxystrobin, pyraclostrobin, trifloxystrobin, 2,4-dihydro-5-methoxy-2-methyl-4-[2-[[[[1-[3-(trifluoromethyl)phenyl]ethylidene]amino]oxy]methyl]phenyl]-3H-1,2,4-triazol-3-one (CAS No. 185336-79-2);
dithiocarbamates, such as:
cufraneb, ferban, potassium N-hydroxymethyl-N′-methyldithiocarbamate, Na or K dimethyldithiocarbamate, macozeb, maneb, metam, metiram, thiram, zineb, ziram;
nitriles, such as:
2,4,5,6-tetrachloroisophthalodinitrile, disodium cyanodithioimidocarbamate;
quinolines, such as:
8-hydroxyquinoline and Cu salts thereof;
other fungicides, such as:
bethoxazin, iprovalicarb, fenhexamid, spiroxamin, carpropamid, diflumetorin, quinoxyfen, famoxadone, polyoxorim, acibenzolar-S-methyl, furametpyr, thifluzamide, methalaxyl-M, benthiavalicarb, metrafenon, cyflufenamid, tiadinil.

The fungicides are very particularly preferably azaconazole, bromuconazole, cyproconazole, dichlorobutrazol, diniconazole, hexaconazole, metaconazole, penconazole, propiconazole, tebuconazole, dichlofluanid, tolylfluanid, fluorfolpet, methfuroxam, carboxin, benzo[b]thiophene S,S-dioxide carboxylic acid cyclohexylamide, fenpiclonil, butenafin, imazalil, N-octylisothiazolin-3-one, dichloro-N-octylisothiazolinone, mercaptobenzothiazole, thiocyanatomethylthiobenzothiazole, thiobendazole, N-butylbenzisothiazolinone, 1-hydroxy-2-pyridinethione (and Cu, Na, Fe, Mn and Zn salts thereof), tetrachloro-4-methylsulfonylpyridine, 3-iodo-2-propynyl-n-butyl carbamate, bethoxazin, 2,4,5,6-tetrachloroisophthalodinitrile, carbendazim.

The bactericides are preferably:

formaldehyde and formaldehyde-eliminating compounds, such as:
benzyl alcohol mono(poly)hemiformal, n-butanol hemiformal, dazomet, ethylene glycol hemiformal, hexahydro-S-triazine, hexamethylenetetramine, N-hydroxymethyl-N′-methylthiourea, N-methylolchloracetamide, oxazolidine, paraformaldehyde, tauroline, tetrahydro-1,3-oxazine, N-(2-hydroxypropyl)amine methanol, tetramethylolacetylenediurea;
isothiazolinones, such as:
N-methylisothiazolin-3-one, 5-chloro-N-methyl isothiazolin-3-one, 4,5-trimethylene-isothiazolinone, 4,5-benzisothiazolinone;
aldehydes, such as:
cinnamaldehyde, formaldehyde, glutaraldehyde, β-bromocinamaldehyde, o-phthalaldehyde;
quaternary ammonium compounds and guanidines, such as:
benzalkonium chloride, benzyldimethyltetradecylammonium chloride, benzyldimethyldodecylammonium chloride, dichlorobenzyldimethylalkylammonium chloride, didecyldimethylammonium chloride, dioctyldimethylammonium chloride, N-hexadecyltrimethylammonium chloride, 1-hexadecylpyridinium chloride, iminooctadine tris(albesilate);
phenols, such as:
tribromophenol, tetrachlorophenol, 3-methyl-4-chlorophenol, 3,5-dimethyl-4-chlorophenol, dichlorophene, 2-benzyl-4-chlorophenol, triclosan, diclosan, hexachlorophene, p-hydroxybenzoic acid ester, o-phenylphenol, m-phenylphenol, p-phenylphenol, 4-(2-tert-butyl-4-methylphenoxy)phenol, 4-(2-isopropyl-4-methylphenoxy)phenol, 4-(2,4-dimethylphenoxy)phenol and the alkali metal and alkaline earth metal salts thereof;
microbicides having an activated halogen group, such as:
bronopol, bronidox, 2-bromo-2-nitro-1,3-propanediol, 2-bromo-4′-hydroxyacetophenone, 1-bromo-3-chloro-4,4,5,5-tetramethyl-2-imidazoldinone, β-bromo-β-nitrostyrene, chloracetamide, chloramine T, 1,3-dibromo-4,4,5,5-tetramethyl-2-imidazoldinone, dichloramine T, 3,4-dichloro-(3H)-1,2-dithiol-3-one, 2,2-dibromo-3-nitrilepropionamide, 1,2-dibromo-2,4-dicyanobutane, halane, halazone, mucochloric acid, phenyl 2-chlorocyanovinyl sulfone, phenyl 1,2-dichloro-2-cyanovinyl sulfone, trichloroisocyanuric acid;

The polymer matrix containing in particular fungicides and/or algicides and their application media, for example the renders and paints prepared therewith, have broad biological activity against fungi and algae.

For examples, microorganisms of the following genera may be mentioned as fungi:

Alternaria, such as Alternaria tenuis,
Aspergillus, such as Aspergillus niger,
Chaetomium, such as Chaetomium globosum,
Coniophora, such as Coniophora puetana,
Lentinus, such as Lentinus tigrinus,
Penicillium, such as Penicillium glaucum,
Polyporus, such as Polyporus versicolor,
Aureobasidium, such as Aureobasidium pullulans,
Sclerophoma, such as Sclerophoma pityophila,
Trichoderma, such as Trichoderma viride.

The algae to be controlled are preferably prokaryotic algae (cyanophyta/blue algae), such as, for example, members of the Coccogoneae subclass and of the Hormogoneae subclass, such as eukaryotic members of the Heterokontophyta, Rhodophyta, Chlorophyta, Euglenophyta, Cryptophyta, Dinophyta and Haptophyta divisions.

In particular, the following fungicides and algicides may be mentioned as particularly preferred active substances:

azaconazole, bromuconazole, cyproconazole, dichlobutrazole, diniconazole, hexaconazole, metaconazole, penconazole, propiconazole, tebuconazole, dichlorofluanide, tolylfluanid, fluorfolpet, methfuroxam, carboxin, benzo[b]thiophene S,S-dioxide carboxylic acid cyclohexylamide, fenpiclonil, butenafin, imazalil, N-octylisothiazolin-3-one, dichloro-N-octylisothiazolinone, mercaptobenzthiazole, thiocyanatomethylthiobenzothiazole, thiabendazole, N-butylbenzisothiazolinone, 1-hydroxy-2-pyridinethione (and their Cu, Na, Fe, Mn and Zn salts), tetrachloro-4-methylsulfonylpyridine, 3-iodo-2-propynyl-n-butyl carbamate, bethoxazin, 2,4,5,6-tetrachlorophthalodinitrile, triadimefon, carbendazim, terbutryn, cybutryn, diuron, benzthiazuron, methabenzthiazuron, and isoproturon, and their mixtures.

Preferred active substance content of the polymer matrix according to the invention is preferably from 5 to 80% by weight, in particular from 5 to 70% by weight and particularly preferably from 15 to 70% by weight.

Owing to the milling, the particles of the matrix according to the invention are preferably distinguished by an irregular shape, in particular having grooves and/or furrows, the distribution of the active substance in the polymer matrix being very substantially uniform owing to the extrusion. Particularly preferably, the polymer matrix according to the invention has a VOC (volatile organic content) of less than 1% by weight, in particular less than 100 ppm, particularly preferably of 10 ppm. In this context, VOC is understood as meaning compounds having a boiling point of <250° C. at atmospheric pressure.

In a particular embodiment, the polymer matrix according to the invention is characterized in that its content of polymer and biocidal active substance together is greater than 90% by weight, in particular greater than 95% by weight.

The invention furthermore relates to a process for the preparation of the particulate polymer matrix according to the invention, which is characterized in that

a) a thermoplastic polymer and a biocidal active substance are mixed,
b) the mixture obtained after a) is extruded at a temperature of from 30 to 200° C. and
c) the extrudate obtained after b) is comminuted to a particle size such that more than 90%, in particular more than 95%, of all particles are smaller than 100 μm.

The mixing of polymer and biocidal active substance is preferably effected by mixing of active substance, the polymer, preferably in granulated or powdered form, and optionally further auxiliaries, such as inorganic extenders, such as ground natural minerals, such as kaolins, aluminas, talc, chalk, quartz, attapulgite, montmorillonite or diatomaceous earth, and ground synthetic minerals, such as finely divided silica, aluminum oxide and silicates, plasticizers and stabilizers.

The extrusion according to step b) is preferably effected by bringing the mixture of the thermoplastic polymer and the active substance into intimate contact with one another at elevated temperature, preferably at from 30 to 200° C., and kneading and hence homogenizing said mixture. Technically, extruders which are generally designed as coextruders but may also be screw extruders are used for this purpose. The screw extruders may be equipped either with only one screw or with a twin screw. They are loaded with the mixture obtained after a) through a feed hopper or another feed device. While the screw is transporting the solid mixture through the extruder, said mixture is first heated and then homogenized and plasticated in the screw at elevated temperature. Thereafter, the extrudate is forced out of the extruder via a die, in general as an extrudate. Both single-screw and multiscrew extruders can be used for the extrusion.

The various temperatures occurring in the extruder may vary within a large temperature range; in general, the homogenization takes place in a range from 20 to 250° C. Depending on the polymer and active substance used, a temperature of from 30 to 200° C. is preferably employed.

The contact times in the extruder or the actual kneading times in the heated part of the extruder may vary within a very wide range. In general, the contact times are from 5 seconds to 5 minutes, preferably from 10 seconds to 2 minutes.

One or more extruder passes are run, depending on requirements.

After the extrusion, the extrudate is obtained as a rule in the form of strands, which are then comminuted by suitable means to the size of less than 100 μm. In principle, all mills which are capable of sufficiently comminuting the corresponding extrudate can be used here.

This can be milled both in dry and in moist form, for example in water. Here, collision, impact, pressure, friction or shearing can be used as active principles of the comminution, the milling members executing rotary, vibratory, tumbling or back-and-forth movements here. For example, ball mills, cutter mills, hammer mills, including jet mills, such as, for example, fine impact mills, opposed-jet mills, crossflow mills or spiral jet mills, may be mentioned here. Further mills are, for example, roll mills, tubular mills, disk mills, toothed disk mills, vibratory mills, cone mills, spring roller mills, centrifugal roller mills or crosshammer mills. In the case of soft polymers, the milling can also be carried out at reduced temperatures in order to achieve sufficient brittleness of the milled material. Carbon-dioxide, ice or liquid nitrogen can be used as coolants here, or the mills are cooled to the corresponding temperature by corresponding cooling units.

The invention furthermore relates to dispersions containing at least the particulate polymer matrix according to the invention. Pastes may also be mentioned as aqueous dispersions.

The dispersions are preferably aqueous dispersions. The dispersions optionally contain surfactants, wetting agents, thickeners, antifoams, preservatives and stabilizers in addition to the particulate polymer matrix.

All surfactants or mixtures of surfactants which are usually used for the preparation of suspensions can be used as surfactants which can optionally be additionally used. The following may be mentioned here by way of example: nonionogenic and anionic emulsifiers, such as polyoxyethylene fatty acid esters, polyoxyethylene fatty alcohol ethers, alkylaryl polyglycol ethers, alkanesulfonates, alkylsuphates, arylsulfonates and protein hydrolysis products.

Preferably used wetting agents are oligo- or polyalkylene glycols or triols, or ethers of the abovementioned compounds. Ethylene glycol, diethylene glycol, triethylene glycol, tetraethylene glycol, polyethylene glycol, propylene glycol, dipropylene glycol, polypropylene glycol, glycerol or mono- or dimethyl, ethyl, propyl or butyl ethers of the abovementioned compounds are very preferably used.

Thickeners which can be used in principle are all substances which build up a three-dimensional structure in water and can therefore prevent or retard sedimentation. Polysaccharides, xanthan gum, sodium or magnesium silicates, heteropolysaccharides, alginates, carboxymethylcellulose, gum arabic or polyacrylic acids are preferably used. Xanthan gum is very preferably used.

Antifoams used are in general surface-active compounds which are only slightly soluble in the surfactant solution. They are preferably antifoams which are derived from natural fats and oils, petroleum derivatives and silicone oils.

The stabilizers which can optionally be used are antioxidants, free radical scavengers or UV absorbers. Optionally, one or more of these substances can be used.

The dispersions according to the invention can be prepared, for example, by milling together the particulate polymer matrix and the further substances present in the dispersion or mixing them intimately with one another by means of a dissolver.

The dispersions contain in general from 2 to 95% by weight of the particulate polymer matrix according to the invention, preferably from 5 to 75% by weight.

The invention furthermore relates to solid formulations containing, in addition to the particulate polymer matrix, also solid extenders, such as, for example, ground natural minerals, such as kaolins, aluminas, talc, marble, chalk, quartz, attapulgite, montmorillonite or diatomaceous earth, and ground synthetic minerals, such as finely divided silica, aluminum oxide and silicates.

The formulations can be obtained by intimate mixing of the particulate polymer matrix with the solid extenders or by milling them together. Likewise, they can be obtained by drying, for example, spray drying, of a liquid mixture of solids.

The solid formulations contain in general from 10 to 98% by weight of the particulate polymer matrix according to the invention, preferably from 15 to 85% by weight.

The formulations may additionally contain further substances, such as stabilizers, container preservatives and further nonextruded fungicides or algicides.

The invention furthermore relates to the use of the particulate polymer matrix according to the invention of the liquid or solid formulations according to the invention as a microbicidal composition for protecting industrial materials. In particular, the industrial materials are adhesives, glues, paper, cardboard, leather, wood, wood-based materials, water-plastic composites, paints, cooling lubricants or heat-transfer liquids.

In the case of renders or paints, in particular emulsion paints, the particulate polymer matrix can be incorporated directly or in the form of the dispersion according to the invention or solid formulation.

Emulsion paints are understood as meaning aqueous, alkaline paints based on polymer dispersions which serve as binders. The polymer dispersions used for the production of emulsion paints contain, by way of example and preferably, polyacrylates, styrene acrylates, polyvinyl acetate, polyvinyl propionate and other polymers.

The concentrations for use of the particulate polymer matrix or dispersions or solid formulations according to the invention which are to be used depend on the type and the occurrence of the microorganisms to be controlled and on the composition of the material to be protected. The optimum amount used can be determined by test series.

The prepared paints, in particular emulsion paints, or renders contain in general from 0.001% by weight to 20% by weight, preferably from 0.01% by weight to 10% by weight, of the particulate polymer matrix according to the invention.

### EXAMPLES

### Preparation Examples

### Example 1

300 g of polyethylene glycol, 35 000 g/mol (granules), and 300 g of terbutryn were weighed into a 2 l glass bottle and mixed on a roller mixer.

The mixture thus obtained was passed three times via an extruder (from Buss; plant type PLK 46 L), the extrudate being cooled in each case on a chill roll and being mechanically comminuted for the next pass.

The following extruder conditions were measured for the passes:

| | | |
|---|---|---|
| T1 = 43.4° C. | T2 = 54.8° C. | T3 = 57° C. |
| T1 = 37° C. | T2 = 56° C. | T3 = 57° C. |
| T1 = 50° C. | T2 = 91° C. | T3 = 88° C. |

T1 is the temperature at the end of the plastication zone and at the beginning of the extrusion and homogenization zone
T2 is the temperature in the middle of the extrusion and homogenization zone
T3 is the temperature at the end of the extrusion and homogenization zone

The extrudates obtained were coarsely precomminuted.

The material was precomminuted twice via a Bexmill (grater mill), milled with an LSM 100 (spiral jet mill) and the milled material was screened via a Rhewum air jet sieve LPK 400 having a mesh size of 45 μm.

### Example 2

490 g of polyethylene glycol, 35 000 g/mol (granules), and 210 g of terbutryn were weighed into a 2 l glass bottle and mixed on a roller mixer.

The mixture thus obtained was passed three times via an extruder (from Buss; plant type PLK 46 L), the extrudate being cooled in each case on a chill roll and being mechanically comminuted for the next pass.

The following extruder conditions were measured for the passes:

| | | |
|---|---|---|
| T1 = 48° C. | T2 = 88° C. | T3 = 84° C. |
| T1 = 48° C. | T2 = 88° C. | T3 = 84° C. |

T1 is the temperature at the end of the plastication zone and at the beginning of the extrusion and homogenization zone
T2 is the temperature in the middle of the extrusion and homogenization zone
T3 is the temperature at the end of the extrusion and homogenization zone

The extrudates obtained were coarsely precomminuted.

The material was precomminuted twice via a Bexmill (grater mill), milled with an LSM 100 (spiral jet mill) and the milled material was screened via a Rhewum air jet sieve LPK 400 having a mesh size of 45 μm.

### Example 3

400 g of polyethylene glycol, 35 000 g/mol (granules), and 400 g of thiabendazole were weighed into a 2 l glass bottle and mixed on a roller mixer.

The mixture thus obtained was passed three times via an extruder (from Buss; plant type PLK 46 L), the extrudate being cooled in each case on a chill roll and being mechanically comminuted for the next pass.

The following extruder conditions were measured for the passes:

| | | |
|---|---|---|
| T1 = 51° C. | T2 = 91° C. | T3 = 88° C. |
| T1 = 51° C. | T2 = 91° C. | T3 = 88° C. |

T1 is the temperature at the end of the plastication zone and at the beginning of the extrusion and homogenization zone
T2 is the temperature in the middle of the extrusion and homogenization zone
T3 is the temperature at the end of the extrusion and homogenization zone

The extrudates obtained were coarsely precomminuted.

The material was precomminuted twice via a Bexmill (grater mill), milled with an LSM 100 (spiral jet mill) and the milled material was screened via a Rhewum air jet sieve LPK 400 having a mesh size of 45 μm.

### Example 4

256 g of Eudragid RS 100 (copolymer of acrylic acid and methacrylic acid having a small proportion of quaternary ammonium groups, average molecular weight 150 000) and 256 g of thiabendazole were weighed into a 2 l glass bottle and mixed on a roller mixer.

The mixture thus obtained was passed twice via an extruder (from Buss; plant type PLK 46 L), the extrudate being cooled in each case on a chill roll and being mechanically comminuted for the next pass.

The following extruder conditions were measured for the passes:

| | | |
|---|---|---|
| T1 = 111° C. | T2 = 121° C. | T3 = 128° C. |
| T1 = 111° C. | T2 = 121° C. | T3 = 128° C. |

T1 is the temperature at the end of the plastication zone and at the beginning of the extrusion and homogenization zone
T2 is the temperature in the middle of the extrusion and homogenization zone
T3 is the temperature at the end of the extrusion and homogenization zone

The extrudates obtained were precomminuted in a mortar.

Milling was effected at room temperature using a Bauermeister UTL mill (turbowheel mill) and the milled material was screened via a Rhewum air jet sieve LPK 400 having a mesh size of 45 μm.

What is claimed is:

1. A particulate polymer matrix containing a biocidally active substance homogeneously distributed in the polymeric matrix, characterized in that
the polymer is a thermoplastic polymer,
more than 90% of all particles having a particle size of less than 100 μm, preferably from 1 to 50 μm, and
the polymer matrix having an active substance content of from 2 to 80% by weight.

2. The polymer matrix as claimed in claim 1, characterized in that the polymer is at least one polymer selected from the group consisting of polyacrylates, polyalkylene glycols, polyurethanes and polyamides.

3. The polymer matrix as claimed in claim 1, characterized in that it contains at least one of the following active substances: fungicides, algicides, insecticides, bactericides.

4. The polymer matrix as claimed in claim 1, characterized in that it contains at least one of the following active substances: tebuconazole, propiconazole, triadimefon, dichlofluanid, tolylfluanid, bethoxazin, fluorfolpet, folpet, N-octylisothiazolin-3-one, dichloro-N-octylisothiazolin-3-one, 1-hydroxy-2-pyridinethione Zn salt, 3-iodo-2-propynylbutyl carbamate, 2,4,5,6-tetrachlorophthalodinitrile, procloraz, thiabendazole, carbendazim, terbutryn, cybutryn, diuron, benzthiazuron, methabenzthiazuron, isoproturon, benzisothiazolin-3-one and bronopol.

5. The polymer matrix as claimed in claim 1, characterized in that it has a VOC content of less than 1% by weight, in particular less than 100 ppm, particularly preferably of 10 ppm.

6. The polymer matrix as claimed in claim 1, characterized in that its content of polymer and biocidal active substance together is greater than 90% by weight, in particular greater than 95% by weight.

7. A process for the preparation of a particulate polymer matrix as claimed in claim 1, characterized in that
a) a thermoplastic polymer and a biocidal active substance are mixed,
b) the mixture obtained after a) is extruded at a temperature of from 30 to 300° C. and
c) the extrudate obtained after b) is comminuted to a particle size such that more than 90%, in particular more than 95%, of all particles are smaller than 100 μm.

8. A dispersion, in particular aqueous dispersion, containing at least one particulate polymer matrix as claimed in claim 1.

9. A solid formulation containing at least one particulate polymer matrix as claimed in claim 1 and solid extenders.

10. The solid formulation as claimed in claim 9, characterized in that the solid extenders used are ground natural minerals and/or ground synthetic minerals.

11. The use of a particulate polymer matrix as claimed in claim 1 or of a dispersion as claimed in claim 8 or of a solid formulation as claimed in claim 9 as a microbicidal composition for protecting industrial materials.

12. The use as claimed in claim 11, characterized in that the industrial materials are adhesives, glues, paper, cardboard, leather, wood, wood-based materials, wood-plastic composites, paints, cooling lubricants or heat-transfer liquids.
